(19) United States
(12) Patent Application Publication
(10) Pub. No.: US 2012/0103267 A1
(43) Pub. Date: May 3, 2012

(54) NOVELTY PET TRAY

(76) Inventor: Jo AMIG, New Cumberland, PA (US)

(21) Appl. No.: 12/915,151

(22) Filed: Oct. 29, 2010

(51) Int. Cl. A01K 5/00; A01K 29/00

(52) U.S. Cl. 119/61.3; 119/61.55

(57) ABSTRACT

A pet nourishment device is disclosed. The pet nourishment device is a novelty pet nourishment device that resembles a portable commode device. The pet nourishment device may include one or more containers of different depths to accommodate pets of different sizes.

### FIELD OF THE INVENTION

The application generally relates to a novelty pet nourishment device, and more particularly to a novelty pet food and/or water tray that resembles a portable handicapped designed toilet.

### BACKGROUND

It has been observed that pets, particularly dogs, may visit a household bathroom toilet or commode for a drink of water. The sight of this activity is humorous to many individuals.

Novelty apparatus for delivering water and water and food to pets that resemble a household toilet have been disclosed in U.S. Pat. Nos. 6,205,950 and 5,904,117, respectively. However, these apparatus are complex, expensive and less portable than desired by many users.

What is needed is an inexpensive, simple and portable novelty pet tray.

Intended advantages of the disclosed systems and/or methods satisfy one or more of these needs or provide other advantageous features. Other features and advantages will be made apparent from the present specification. The teachings disclosed extend to those embodiments that fall within the scope of the claims, regardless of whether they accomplish one or more of the aforementioned needs.

### SUMMARY

The following embodiments and aspects thereof are described and illustrated in conjunction with systems and methods that are meant to be exemplary and illustrative, not limiting in scope. In various embodiments, one or more of the limitations described above in the Background have been reduced or eliminated, while other embodiments are directed to other improvements.

A first embodiment of the disclosure includes a novelty pet nourishment device including a frame, a toilet seat attached to the frame, and a container for delivering pet nourishment. The frame includes a plurality of legs, one or more braces for forming the plurality of legs into a frame resembling a chair frame for a toilet for invalid patients. The container is positioned under the toilet seat.

Another embodiment of the disclosure includes a pet nourishment device including a frame, an annular support attached to the frame, and a container for delivering pet nourishment. The frame includes a plurality of legs and one or more braces for forming the plurality of legs into a frame. The container is positioned under the toilet seat.

Alternative exemplary embodiments relate to other features and combinations of features as may be generally recited in the claims.

### BRIEF DESCRIPTION OF THE FIGURES

FIG. 1 is a front perspective view of a pet nourishment device according to the invention.

FIG. 2 is a rear view of the device of FIG. 1.

FIG. 3A is a perspective view of an embodiment of a base and container according to the invention.

FIG. 3B is a side view of the base and container of FIG. 3A.

FIG. 4 is a rear view of another embodiment of a pet nourishment device according to the invention.

Wherever possible, the same reference numbers will be used throughout the drawings to refer to the same or like parts.

### DETAILED DESCRIPTION OF THE EXEMPLARY EMBODIMENTS

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

The present disclosure provides novel solutions for a novelty pet tray capable of providing food and/or water to a pet.

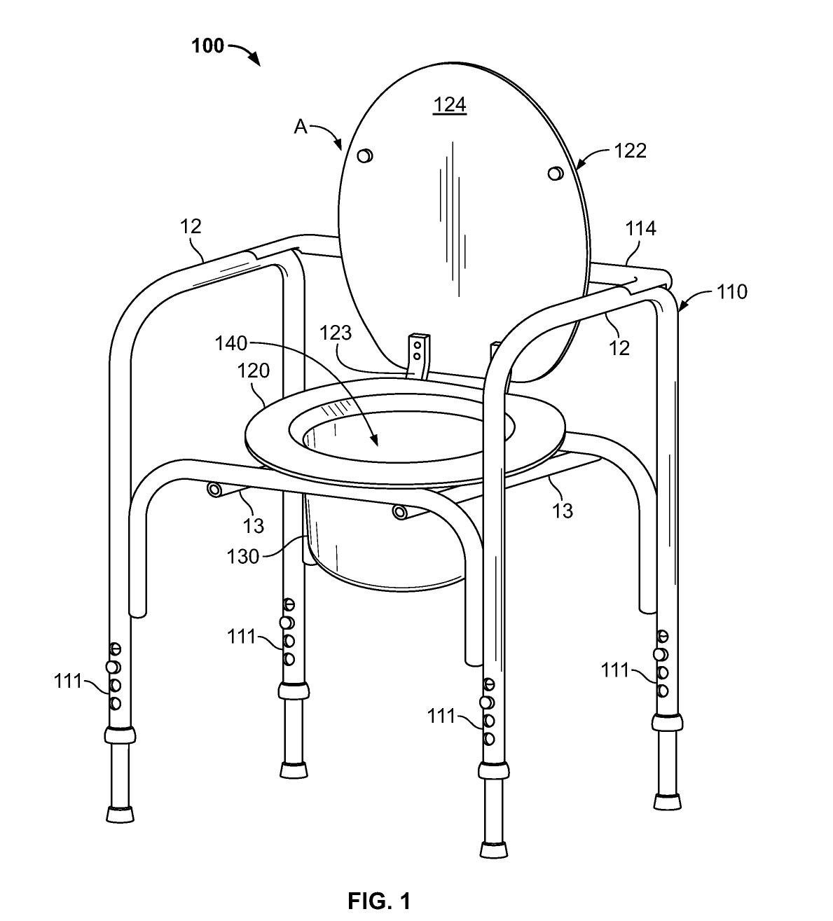

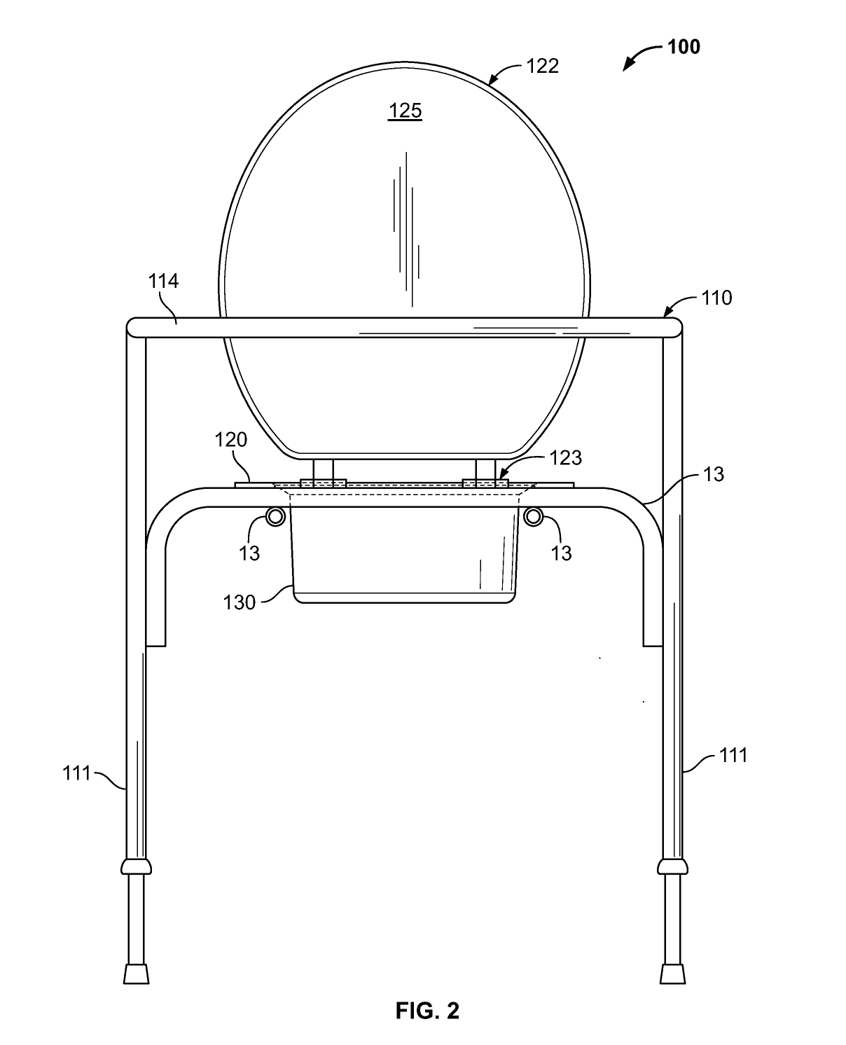

FIGS. 1 and 2 illustrates an overview of the present invention, in accordance with various embodiments. As illustrated in FIG. 1, an embodiment of a novelty pet nourishment device (device) 100 according to the present invention. The device 100 includes a frame 110, a base 120, a lid 122 and a receptacle or bowl 130. The frame 110 is made of a tubular material, such as, a metal or polymer. In this embodiment, the tubular material has a generally circular cross section. In another embodiment, the tubular material may have an oval, square, rectangular, hexagonal or other geometric shape. In an embodiment, the metal may be, but is not limited to, a chromed plated steel or aluminum alloy. The polymer may be, but is not limited to polyvinyl chloride.

The frame 110 includes a plurality of legs 111, arms 112, frame members 113, and a back brace 114. The legs 111 are telescopically adjustable in height, and in such a manner adjust the height of the bowl 130. In this exemplary embodiment, the legs 111 include a connector 115, such as the push button connector described in U.S. Pat. No. 3,947,140, issued on Mar. 30, 1976. In another embodiment, the connector 115 may be a clamp or device to adjustably position the length of the legs 111.

In this exemplary embodiment, two of the legs 111 and one of the arms 112 disposed between the two legs 111 are at least partially formed of a single, continuous tube. In another embodiment, one or more members of the frame 110 are formed of separate components that are joined by fasteners or a joining process such as brazing or welding. The frame members 113 form the frame 110 resembling a commode device for invalid patients, such as the commode device disclosed in U.S. Pat. No. 4,837,868, issued Jun. 13, 1989, incorporated herein in the entirety by reference.

The base 120 has a general disk shape or geometry including a support portion disk portion 121 and an annular opening 140. The disk portion 121 has an upper surface 121a. The base 120 is attached to the frame 110 by fasteners (not shown). In one embodiment, the base 120 is attached to the frame by hinged fasteners that allow the base 120 to pivot from a level position as shown in FIG. 1, to an open or lifted position (not shown) proximate to the lid 122 (in an open position A) adjacent the back brace 114.

The lid 124 is connected by hinges 127 to the base 120 so as to pivot about the hinges 123 from an open position A as shown in FIG. 1, to a closed position (not shown) over and in contact with the base 120. The lid 122 includes a bottom surface 124 (FIG. 1) and a top surface 125 (FIG. 2). The top and/or bottom surfaces 124, 125 may include a design (not shown), such as, but not limited to, a school logo, company logo, or famous quote. In another embodiment, the lid 122 is pivotally connected to the frame 110 instead of the base portion. In yet another embodiment, the lid 122 may be non-pivotally attached to either or both the base 120 and/or the frame 110. In yet another embodiment, a seal (not shown) is provided on the base 120 and/or lid 122 to provide an air tight seal closing the container 130. The seal may be, but is not limited to, a seal ring or lip and groove seal, between the top portion 122 and the base 120 and/or lid 122.

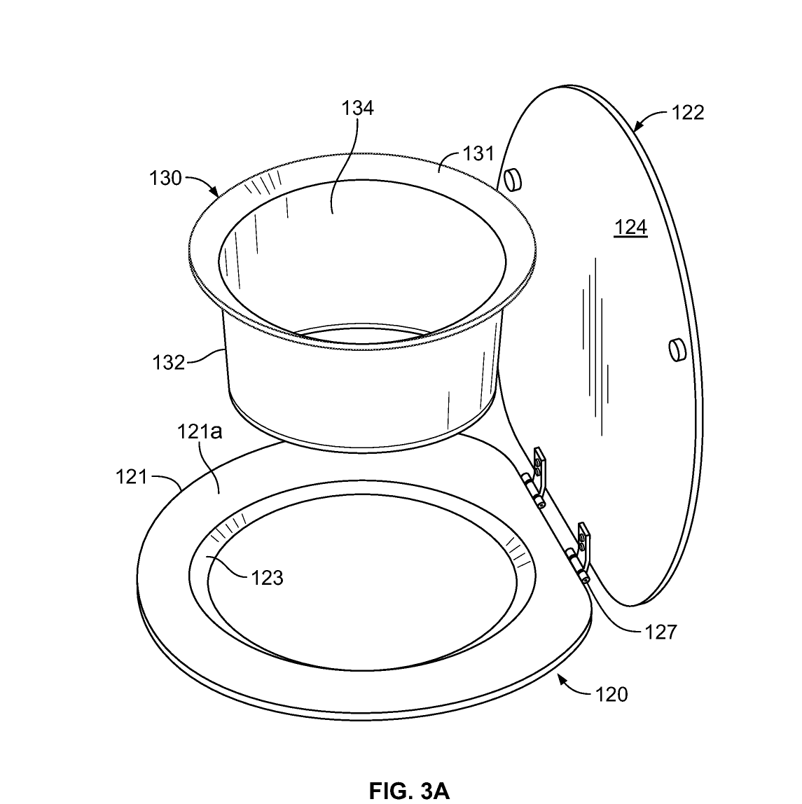

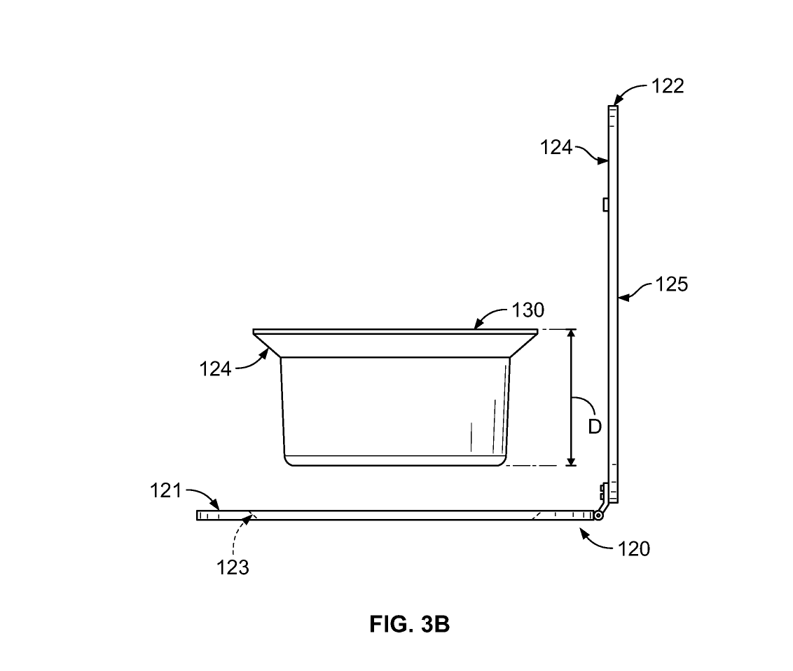

FIGS. 3A and 3B shows a more detailed illustration of the container 130, base 120 and lid 122. As can be seen in FIG. 3, the container 130 includes a rim 131 and a body portion 132. The rim 131 may include recesses, lips, handles or protrusions (not shown) to assist an operator in lifting the container 130. In another embodiment, the container 130 may include recesses, lips, handles or protrusions (not shown) on the rim 131 and/or body portion 132 to assist an operator in lifting the container 130. The rim 131 includes a support surface 124. The container 130 includes an interior space 134. In another embodiment, the container 130 may include one or more interior spaces (not shown) separated by one or more dividers or partitions (not shown). The container 130 may be formed of any suitable material for the temporary storage of pet food and/or water, including, but not limited to a metal or polymer. The metal may be, but is not limited to, a chromed plated steel or aluminum alloy. The polymer may be, but is not limited to, polyvinyl chloride.

The container 130 has a depth D. In one embodiment, the depth D may be between about 1 inch and about 10 inches. In another embodiment, the depth D may be between about 2 inches and about 8 inches. In yet another embodiment, the depth D may be between about 4 inches and about 6 inches. In another embodiment, the device 100 includes two or more containers 130. In one embodiment, the two or more containers 130 have different depths D. In such a manner, the depth may be selected for the type of nutrition provided. For example, the device 100 may include a first container having a first depth for water and a second container having a second depth for food, wherein the first and second depths are different. In yet another embodiment, the two or more containers may have the same depth.

As can further be seen in FIGS. 3A and 3B, the base 120 further includes a support portion 123. The support portion 123 is configured to receive the corresponding support surface 124 of container 130. In this exemplary embodiment, the support portion 123 and container support surface 124 are inclined. In another embodiment, the support portion 123 and container support surface 124 may be correspondingly stepped, ridged, or otherwise correspondingly supporting. In yet another embodiment, the support portion 123 may include a fastener, such as but not limited to a hook, lip, clasp or other attachment device for releasably supporting the container 130. In yet another embodiment, the support portion 123 may include a fastener portion for receiving a fastener attached to the container 130. In another embodiment, the base 120 may include one or more fasteners (not shown) for pivotally attaching the base 120 to the frame 110. In yet another embodiment, the base 120 and the container 130 are a single formed body.

In another embodiment, the base 120 may not include a support portion 123, and the container 130 may be supported by the top surface 120a. In this embodiment, the container 130 is supported by the surface 121a of the base portion 121, or in other words, by the rim 131 of the container 130 resting upon the surface 121a of the base portion 121.

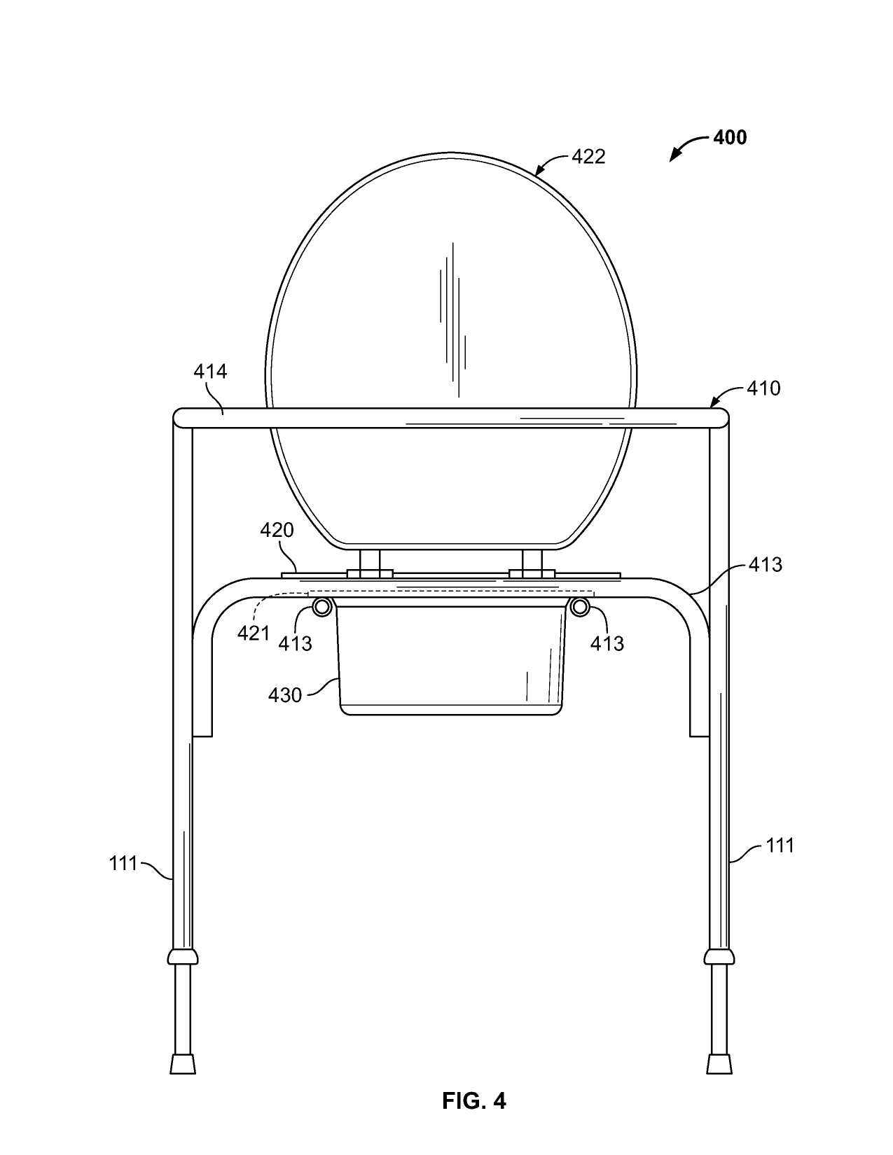

FIG. 4 shows another embodiment of a novelty pet nourishment device (device) 400. As can be seen in FIG. 4, the container 430 is supported by the frame members 413 of frame 410 and not the base 420 as shown in the exemplary embodiment of FIGS. 1-3A, 3B. In one embodiment, the base 420 may be a conventional or standard commercial toilet seat attached to the frame 410. In another embodiment, the base 420 and lid 422 may be a conventional or standard commercial toiler seat and lid, where the seat is attached to the frame 410. In another embodiment, the frame 410 supports one or more bases 420 and associated containers 430. For example, the frame 410 may be configured to support two bases 420 and associated containers 430. In such a manner, a first base/container combination 420/430 may be used to provide water and a second base/container 420/430 may be used to provide pet food.

While the disclosure has been described with reference to exemplary embodiment, it will be understood by those skilled in the art that various changes may be made and equivalents may be substituted for elements thereof without departing from the scope of the disclosure. The order or sequence of any process or method steps may be varied or re-sequenced according to alternative embodiments. Other substitutions, modifications, changes and omissions may be made in the design, operating conditions and arrangement of the exemplary embodiments without departing from the scope of the present application. It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims. It is therefore intended that the following appended claims and claims hereafter introduced are interpreted to include all such modifications, permutations, additions, and sub-combinations as are within their true spirit and scope.

What is claimed is:

1. A novelty pet nourishment device, comprising:
a frame comprising:
a plurality of legs; and
one or more braces joining the plurality of legs;
a base attached to the frame; and
one or more containers for delivering pet nourishment,
wherein at least one of the one or more containers is supported by the base or by the frame; and
wherein the device resembles a portable toilet for invalid patients.

2. The device of claim 1, further comprising a lid configured to rotated about an open and closed position over the one or more containers.

3. The device of claim 1, wherein the one or more containers comprises two or more containers having different depths.

4. The device of claim 1, wherein the at least one of the one or more containers is supported by the one or more braces.

5. The device of claim 1, wherein the one or more of the at least one containers is supported by the base.

6. The device of claim 1, wherein the plurality of legs are extendable.

7. The device of claim 1, wherein the plurality of legs are tubular legs having a substantially circular cross section.

8. The device of claim 1, wherein the one or more of the at least one containers comprises a container having two or more separate interior spaces.

9. The device of claim 1, wherein one or more containers includes two or more interchangeable containers.

10. The device of claim 2, wherein the lid is pivotally attached to the base or frame so as to pivot between an open and closed position over the container.

11. The device of claim 9, wherein the two or more interchangeable containers have different depths.

12. A pet nourishment device, comprising:
a frame comprising:
a plurality of legs;
one or more braces for forming the plurality of legs into the frame;
a base attached to the frame;
one or more containers for delivering pet nourishment; and
a lid configured to pivot between an open and closed position over the container;
wherein the at least one of the one or more containers is supported by the frame or the base.

13. The device of claim 12, wherein the one or more containers includes two or more interchangeable containers.

14. The device of claim 12, wherein the one or more containers are supported by the one or more braces of the frame.

15. The device of claim 12, wherein the plurality of legs are extendable.

16. The device of claim 12, wherein the plurality of legs are tubular legs having a substantially circular cross section.

17. The device of claim 12, wherein at least one of the one or more containers comprises one or more separate interior spaces.

18. The device of claim 12, wherein the lid is pivotally attached to the base or frame.

19. The device of claim 12, wherein the base is a toilet seat.

20. The device of claim 13, wherein the two or more interchangeable containers have different depths.
